(19) United States
(12) Patent Application Publication
(10) Pub. No.: US 2014/0280459 A1
(43) Pub. Date: Sep. 18, 2014

(54) CONTROL OF AN APPLICATION ON A REMOTE COMPUTER DEVICE

(71) Applicant: Jeremy Debate, Boston, MA (US)

(72) Inventor: Jeremy Debate, Boston, MA (US)

(21) Appl. No.: 14/208,093

(22) Filed: Mar. 13, 2014

Related U.S. Application Data
(60) Provisional application No. 61/781,498, filed on Mar. 14, 2013.

(51) Int. Cl. H04L 29/08

(52) U.S. Cl. CPC H04L 67/10
USPC 709/202

(57) ABSTRACT

An application installed on a host computer device includes a portion of originally compiled executable code derived from respective source code and a modification to the originally compiled executable code. The portion of originally compiled executable code supports functionality in accordance with the source code from which the originally compiled executable code is derived. The modification to the originally compiled executable code includes agent code. In response to receiving a request to execute the modified compiled application on a host computer device on which the modified compiled application is installed, the host computer device executes the application as well as executes a respective agent on the host computer device as specified by the modification. Via the agent, which is integrated into the application, the host computer device provides functionality such as control of the executed application on the host computer device from a remote source.

### RELATED APPLICATIONS

This application is related to and claims the benefit of earlier filed U.S. Provisional Patent Application Ser. No. 61/781,498 entitled “CONTROL OF AN APPLICATION ON A REMOTE COMPUTER DEVICE,”, filed on Mar. 14, 2013, the entire teachings of which are incorporated herein by this reference.

### BACKGROUND

Computer software has been developed to enable a user to control a remotely located computer device. For example, so-called remote desktop software from Microsoft™ enables a user to input commands at a local personal computer to control the remotely located computer over a network.

When using remote desktop software, the local computer operated by the user first establishes a communication link with the remote computer to be controlled. Via display information received from the remote computer, the local computer (from which the remote computer device is controlled) locally displays a copy of images that are currently displayed on the remote computer. Accordingly, the user at the local computer is able to view images such as windows, symbols, etc., that are currently displayed on the remote computer being controlled.

To control the remote computer, the user inputs commands at the local computer with respect to the locally displayed images (i.e., copies of images of the computer at the remote location). The user can input commands at the local computer in any suitable manner such as by the user pressing buttons on a keyboard, clicking of a computer mouse, etc.

The local computer communicates the inputted commands over a network connection to remote desktop software executing on the remote computer being controlled.

The remote desktop software on the remote computer receives the input transmitted over the network and communicates the input to the operating system of the remotely controlled computer. The operating system of the remote computer then determines to which of the applications the input pertains and delivers the input commands to the appropriate applications executing on the remote computer. Thus, according to conventional techniques, the operating system of the remote computer delivers the input directly to the applications for further execution.

The applications executing on the remote computer process the received input (i.e., clicks, drags, drops, pressed keys, etc., received from the remote computer) to identify a particular function of the target application in which to locally execute on the computer being remotely controlled. For example, a particular application on the remotely controlled computer receives the input. A management function in the particular application receives the control input and then identifies a corresponding function in the particular application to execute in accordance with the control input.

### BRIEF DESCRIPTION OF DIFFERENT EMBODIMENTS AS DISCUSSED HEREIN

Conventional applications for remotely controlling a computer device suffer from deficiencies. For example, as discussed above, at the remotely located computer being controlled, the remote desktop application communicates the received input to a respective application executing on the remote computer. The respective application receiving the input then initiates execution of a respective function intended by the received input.

The conventional remote desktop software as discussed above is complex, susceptible to being slow, and typically consumes a substantial amount of power. Moreover, conventional remote desktop may only support limited remote control capabilities.

Embodiments herein deviate with respect to conventional techniques. For example, one embodiment herein includes a novel way of controlling a target application on a remotely located mobile computer device.

More specifically, in accordance with one embodiment, an application administrator receives a compiled application of original executable computer code. The application administrator modifies the compiled application to execute a supplemental function such as an agent function with respect to functions supported by the originally compiled executable code. The modified compiled application can include agent computer code that is executed along with the original executable computer code upon instantiation of the modified compiled application. In one more specific non-limiting example embodiment, the agent computer code is coded as part of the compiled application to provide auxiliary control functions with respect to the application such as remote control of an instantiation of the application (on the host computer device) from a remote source.

In accordance with further embodiments, the application administrator or other suitable resource can provide access to the modified compiled application for installation on one or more host computer devices. In other words, by way of a non-limiting example, the application administrator can make the modified compiled application available to one or more members of an organization. If desired, the compiled application can be modified in a different manner depending on a target user that is intended to install and use the application.

In one embodiment, modification of the originally compiled executable code to produce the modified compiled application is known as wrapping an application.

Assume in this example that a user such as a member of the organization retrieves and installs the modified compiled application onto their host computer device (e.g., a mobile device, laptop computer, desk computer, etc.). In one embodiment, any of multiple members in the organization can retrieve and download the modified compiled application to their respective computer device.

Subsequent to installation, assume that the user of a corresponding host computer device initiates execution of the installed application (e.g., modified compiled application including auxiliary code such as an agent). In such an instance, an operating system of the corresponding host computer device receives a request from a respective user to execute the application installed on the host computer device.

As previously discussed, the application installed on the host computer device includes a portion of originally compiled executable code derived from respective source code and a modification to the originally compiled executable code. In one embodiment, the portion of originally compiled executable code supports functionality in accordance with the source code from which the originally compiled executable code is derived. The modification, as defined by the application administrator or other suitable resource, to the originally compiled executable code includes agent code. In response to the request to execute the modified compiled application on the host computer device, the host computer device executes the application as well as executes a respective agent on the host computer device as specified by the modification. Via the agent associated with or integrated into the executing application, the host computer device provides control of the executed application on the host computer device from a remote source.

Note that wrapping of a compiled application to support agent functionality as discussed herein is shown by way of non-limiting example only and that agent functionality supported by the agent can be associated with an application in any suitable manner.

Additionally, note that the agent computer code or modification is not limited to control of the application from a remote source. For example, the agent computer code can include one or more auxiliary functions enabling different capability as discussed herein.

These and other embodiments are discussed in more detail below.

As mentioned above, note that embodiments herein can include a configuration of one or more computerized devices, workstations, handheld or laptop computers, personal computers, or the like to carry out and/or support any or all of the method operations disclosed herein. In other words, one or more computerized devices or processors in a resource such as a mobile computer device can be programmed and/or configured to operate as explained herein to carry out different embodiments of the invention.

Yet other embodiments herein include software programs to perform the steps and operations as discussed herein. One such embodiment comprises a computer program product including a non-transitory computer-readable storage medium (i.e., any suitable computer readable hardware storage medium) on which software instructions are encoded for subsequent execution. The instructions, when executed in a computerized device having a processor, program and/or cause the processor to perform the operations disclosed herein. Such arrangements are typically provided as software, code, instructions, and/or other data (e.g., data structures) arranged or encoded on a non-transitory computer readable storage medium (i.e., any computer readable hardware storage media) such as an optical medium (e.g., CD-ROM), floppy disk, hard disk, memory stick, etc., or other medium such as firmware or microcode in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, one particular embodiment of the present disclosure is directed to a method and computer program product that includes a computer readable hardware storage medium having instructions stored thereon. For example, in one embodiment, the instructions, when executed by one or more processor devices in a computer system such as a mobile computer device, cause the one or more processor devices to: receive a compiled application of original executable computer code; modify the compiled application to execute agent computer code with respect to the original executable computer code upon instantiation of the application, the agent code coded to provide control of the instantiation of the application from a remote source; and provide access to the modified compiled application for installation on at least one host computer.

Another particular embodiment of the present disclosure is directed to a method and computer program product that includes a computer readable hardware storage medium having instructions stored thereon. For example, in one embodiment, the instructions, when executed by one or more processor devices in a computer system such as a mobile computer device, cause the one or more processor devices to: receive a request to execute an application installed on a host computer device, the application installed on the host computer device including a portion of originally compiled executable code derived from respective source code and a modification to the originally compiled executable code; in response to the request: i) execute the application, and ii) execute an agent on the host computer device as specified by the modification; and via the agent, provide control of the executed application on the host computer device from a remote source.

The ordering of the steps has been added for clarity sake. These steps can be performed in any suitable order.

Other embodiments of the present disclosure include software programs and/or respective hardware to perform any of the method embodiment steps and operations summarized above and disclosed in detail below.

It is to be understood that each of the multitude of systems, methods, apparatuses, instructions on computer readable storage media, etc., as discussed herein can be embodied strictly as a software program, as a hybrid of software and hardware, or as hardware alone such as within a processor, or within an operating system or a within a software application.

Additionally, although each of the different features, techniques, configurations, etc., herein may be discussed in different places of this disclosure, it is intended that each of the concepts can be executed independently of each other or, where suitable, the concepts can be used in combination with each other. Accordingly, the one or more present inventions as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), and additional points of novelty, the reader is directed to the Detailed Description section and corresponding figures of the present disclosure as further discussed below.

### BRIEF DESCRIPTION OF THE DRAWINGS

FIG. 1 is an example diagram illustrating distribution of originally compiled executable code to a remote processing resource that modifies the originally compiled executable code according to embodiments herein.

FIG. 2 is an example diagram illustrating distribution of a modified compiled application including at least a portion of originally compiled executable code and a corresponding modification according to embodiments herein.

FIG. 3 is an example diagram illustrating execution of a modified compiled application according to embodiments herein.

FIG. 4 is an example diagram illustrating remote control of an application on a computer device over a network connection according to embodiments herein.

FIG. 5 is an example diagram illustrating execution of a modified compiled application according to embodiments herein.

FIG. 6 is an example diagram illustrating a draw mode according to embodiments herein.

FIG. 7 is an example diagram illustrating persistence of an agent and/or corresponding communication link in which to control a respective application executing on a host computer device according to embodiments herein.

FIG. 8 is an example diagram illustrating registration information used by respective servers in a notification network facilitating distribution of communications according to embodiments herein.

FIG. 9 is an example diagram illustrating use of a notification network enabling a remote computer resource to communicate with and control a host computer device according to embodiments herein.

FIG. 10 is an example diagram illustrating registration information used by respective servers in a notification network to facilitate distribution of messages according to embodiments herein.

FIG. 11 is an example diagram illustrating an example computer architecture for implementing functionality according to embodiments herein.

FIG. 12 is a flowchart illustrating an example method of producing a modified compiled application according to embodiments herein.

FIG. 13 is a flowchart illustrating an example method of executing an agent on a host computer device according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION AND FURTHER SUMMARY OF EMBODIMENTS

In accordance with embodiments herein, an application installed on a host computer device includes a portion of originally compiled executable code derived from respective source code and a modification to the originally compiled executable code. The portion of originally compiled executable code supports functionality in accordance with the source code from which the originally compiled executable code is derived. The modification to the originally compiled executable code includes agent code. In response to receiving a request to execute the modified compiled application on a host computer device on which the modified compiled application is installed, the host computer device executes the application as well as executes a respective agent on the host computer device as specified by the modification. Via the agent, which is integrated into the application, the host computer device provides functionality such as control of the executed application on the host computer device from a remote source.

Now, more specifically, FIG. 1 is an example diagram illustrating generation and distribution of compiled code according to embodiments herein.

One or more software developers in software developer domain 192 produce source code 112. As is known, the source code 112 can include any collection of computer instructions (e.g., text-based, human readable instructions, data, etc.) to perform respective one or more functions on a computer device.

By further way of a non-limiting example, human software developers can produce the source code 112 using high-level, text-based instructions according to one or more respective computer languages such as C, C++, Visual Basic, etc. The source code 112 may include comments indicating functionality performed by different parts of the source code. Source code 112 can support any suitable type of functionality executable on a respective computer device.

The software vendor or entity that develops source code 112 typically has a desire to prevent unauthorized parties access to source code 112 to prevent copying and/or other misuse of source code 112.

Via compiler resource 122, the software vendor or other suitable resource compiles the source code 112 into compiled code (referred hereafter as originally compiled executable code 125). By way of a non-limiting example, the originally compiled executable code 125 can be low-level machine code understood and executable by a respective host computer device. That is, the originally compiled executable code 125 can be installed on a respective host computer device to perform different functions as coded by respective source code 112.

Thus, in general, the originally compiled executable code 125 is a conversion of the source code 110 into low-level machine code or so-called executable binary.

Embodiments herein include receiving and modifying a compiled application of original executable computer code 125.

More specifically, as shown, a software vendor can make the originally compiled executable code 125 available to one or more respective customers. By way of a non-limiting example, the software vendor can distribute the originally compiled executable code 125 to one or more customers in any suitable manner. For example, in one embodiment, an application administrator 168-1 in organization domain 160 (such as a business entity including one or more members, employees, etc.) can retrieve and/or receive originally compiled executable code 125 from the software vendor over network 190-1 such as the Internet.

Other suitable methods of distributing the originally compiled executable code (e.g., an executable file) can include physical delivery of the originally compiled executable code 125 on non-volatile memory, optical disk, etc., from the software vendor to the application administrator 168-1.

In one embodiment, the application administrator 168-1 or other suitable resource initiates modification of the originally compiled executable code 125 prior to distribution to respective organization members. As an example, via processing resource 140 (e.g., a modifier application), the application administrator 168-1 produces modified compiled application 150-1 (such as low-level, computer machine executable code) based at least in part on originally compiled executable code 125.

The modified compiled application 150-1 can include originally compiled executable code 125-1. By way of a non-limiting example, originally compiled executable code 125-1 can represent all or a portion of the originally compiled executable code 125 provided by the software vendor. Notably, the modified compiled application 150-1 includes modification 151-1 with respect to originally compiled executable code 125.

In one non-limiting example embodiment, the modification 151-1 to originally compiled executable code 125 causes execution of supplemental computer code such as agent computer code with respect to the original executable code 125-1 upon subsequent instantiation (i.e., execution) of the modified compiled application 150-1 on a respective host computer device.

The supplemental code can be low-level computer machine-readable code including one or more computer instructions not originally included in or not originally intended to be executed by the originally compiled executable code 125. Thus, inclusion of the modification 151-1 alters performance of the originally compiled executable code 125.

In accordance with further embodiments, the processing resource 140 can be configured to modify the originally compiled executable code 125 in a number of different ways to produce modified compiled application 150-1.

For example, the processing resource 140 can be configured to modify a header in the originally compiled executable code 125. In such an instance, the modified header (such as modification 151-1) can indicate to load the supplemental code upon execution of the modified compiled application 150-1 on a respective host computer on which the modified compiled application is subsequently installed and executed.

In accordance with another embodiment, the processing resource 140 can be configured to retrieve the supplemental computer code and add, insert, inject, substitute, etc., the supplemental computer code (e.g., a library link, machine code, etc.) into the original executable computer code 125 to produce the modified compiled application 150-1. Some modifications of originally compiled executable code 125 may be needed to insert the originally compiled executable code 125.

If desired, in one embodiment, the processing resource 140 can replace one or more existing load library commands in the originally compiled executable code 125 with one or more replacement load library commands including the supplemental code. The supplemental code, when executed, can include a load instruction to load the one or more original existing load library commands.

In accordance with yet further embodiments, the supplemental code as specified by the modification 151-1 need not be included in the modified compiled application 150-1. Instead, if desired, the modification 151-1 can specify a respective location from which to retrieve the supplemental code.

Additional details of wrapping a compiled application are discussed in related application entitled “MODIFIED COMPILED APPLICATION AND MANAGEMENT USING POLICY,”, filed on the same date as the present application, the entire teachings of which are incorporated herein by this reference. Any suitable method can be used to produce the modified compiled application.

Note that the application administrator 168-1 in organization domain 160 can receive any number of different applications from multiple different software vendors. In a similar manner as discussed above, the application administrator 168-1 can modify originally compiled executable code received for each of multiple different types of software applications that are eventually made available for use by one or more members in the organization.

In one embodiment, the application administrator 168-1 associated with organization domain 160 initiates modification to the originally compiled executable code 125 to produce modified compiled application 150-1. Execution of modified compiled application 150-1 enables control of the corresponding application from a remote source.

Note that as an alternative to receiving compiled code in FIG. 1 and modifying the compiled code to produce a respective modified compiled application, embodiments herein can include receiving a compiled application already including modifications to execute supplemental code supporting functionality such as an agent. In such an instance, there is no need to modify the received originally compiled executable code as discussed herein because the originally compiled executable code can include such functionality.

FIG. 2 is an example diagram illustrating distribution of one or more compiled applications according to embodiments herein.

As shown, the application administrator 168-1 can initiate storage of one or more modified compiled applications 150 (e.g., modified compiled application 150-1, modified compiled application 150-2, modified compiled application 150-3, etc.) in repository 280-1.

As mentioned, each of the modified compiled applications can be created in any suitable manner.

Additionally, each of the modified compiled applications 150 can support different functions. For example, modified compiled application 150-1 may support e-mail management; modified compiled application 150-2 may support web browsing capability; modified compiled application 150-3 may be a word processor application; and so on. A user may wish to install multiple applications on their host computer device (e.g., mobile computer device, stationary computer, etc.).

As previously discussed, the application administrator 168-1 can make the one or more modified compiled applications 150 stored in repository 280-1 available to one or more persons such as user 108-1, user 108-2, user 108-3, etc. The user 108 may be part of an organization.

The application administrator 168-1 can control distribution of the modified compiled applications 150. For example, a first group of one or more users in the organization may be authorized to retrieve and install the modified compiled application 150-1 on their respective host computer device; a second group of one or more users may be authorized to retrieve and install modified compiled application 150-2 on their device; and so on.

In one embodiment, users 108 can view a listing of available applications via access to a web page sponsored by the organization. By way of a non-limiting example, the users 108 can be members (such as employees) of an organization having access to the respective modified compiled applications 150. The users 108 access the web page to download and install one or more respective modified compiled applications 150 (for which they are authorized access) onto their respective host computer devices 210. In a further non-limiting example embodiment, the application administrator 168-1 makes the modified compiled applications 150 available to users so that they are able to more effectively perform their jobs.

A host computer device in this example embodiment can be any suitable type of computer processing device such as an iPhone™, iPad™, Blackberry™, Android™, Smartphone™, personal computer, etc.

Assume, in this example, that the user 108-1 communicates over network 190-2 such as the Internet and retrieves and installs the modified compiled application 150-1 onto host computer device 210-1.

FIG. 3 is an example diagram illustrating execution of the modified compiled application according to embodiments herein.

As previously discussed, the user 108-1 initiates installation of modified compiled application 150-1 on their respective host computer device 210-1. The host computer device 210-1 stores the modified compiled application 150-1 in repository 480-1 of storage domain 420-1.

Subsequent to installation of respective modified compiled application 150-1 on host computer device 210-1, assume that the host computer device 210-1 receives user input 405. User input can include a request to execute the modified compiled application 150-1.

In response to receiving the command, the host computer device 210-1 instantiates the modified compiled application 150-1 as application 150-1-EXE.

Recall that modified compiled application 150-1 (or a version of the application 150-1-EXE including agent computer code generated by respective source code 112) is stored in repository 480-1 in storage domain 410-1 of the host computer device 210-1. Also, as previously discussed, the modified compiled application 150-1 includes all or a portion of the originally compiled executable code 125 produced by the software vendor from the respective source code 110.

In response to receiving the request to execute the modified compiled application 150-1, one or more processor devices in execution domain 420-2 of host computer device 210-1 instantiates and/or executes agent 440 as specified by the modification 151-1. By way of a non-limiting example, agent 440 is integrated with and/or represents part of the instantiated application 150-1-EXE. In one embodiment, the agent 440 has read/write access to a corresponding memory space of the application 150-1-EXE executing on the host computer device. In other words, the functions associated with the modified compiled application 150-1 can be loaded into memory space (e.g., cache, random access memory, etc.) allocated for use by application 150-1-EXE.

As discussed herein, because the agent 440 has read/write access, the agent 440 has the ability to perform functions such as modify attributes of the application. For example, the user at the remote source can communicate with the agent 440 to modify a color of an icon displayed on the display screen 130-2; the user can communicate with the agent 440 to move a selectable symbol on the display screen 130-2 to a new location on the display screen 130-2; etc.

As a specific example, the agent 440 can receive a command from the remote source 170 to modify display parameters of a particular display element associated with the application 150-1-EXE executing on the host computer device 210-1. In response to the command, the agent initiates modification of the display parameters associated with the particular display element. Assume that the particular element is currently displayed on the display screen 130-2. Subsequent to modification of the display parameters, the application 150-1-EXE executing on the host computer device 210-1 initiates display of the display element on the display screen 130-2 in accordance with the modified display parameters. As mentioned, modification of display parameters associated with a display element can include modifying a color of an icon displayed on the display screen 130-2; moving a selectable symbol on the display screen 130-2 to a new location on the display screen 130-2; etc.

In addition to loading supplemental code (to execute agent 440) as specified by the modification 151-1 upon receiving the request to execute modified compiled application 150-1, embodiments herein can include loading one or more libraries in originally compiled executable code 125 to support corresponding data structures, functions 413 (e.g., function 413-1, function 413-2, function 413-3, etc.) associated with application 150-1-EXE.

As discussed below, the user at the remote source can communicate with the agent 440 to control functions of the application 150-1-EXE.

FIG. 4 is an example diagram illustrating remote management of a host computer device using an agent according to embodiments herein.

As shown, communication system 400 includes a remote source 170 (i.e., a remote resource) and respective display screen 130-1. Remote source 170 can be any type of computer device or communication device enabling a user to provide input commands to control the host computer device 210-1.

Assume in this example that the modified compiled application 150-1 has been instantiated as application 150-1-EXE on host computer device 210-1 as shown. Application 150-1-EXE includes agent 440 and application core 475. In one embodiment, application core 475 includes functionality defined by originally compiled executable code 125-1; agent 440 represents functionality as specified by modification 151-1.

In accordance with further example embodiments, to support communications, agent 440 establishes communication link 105-1 with a respective resource in network 190-3. To communicate with agent 440 in host computer device 210-1, the remote source 170 establishes communication link 105-8 with a resource in network 190-3. A combination of communication links 105-1 and 105-8 supports bi-directional communication between the remote source 170 and the agent 440 on the host computer device 210-1.

By way of a non-limiting example, the communication link 105-1 established by agent 440 can be a persistent network connection between the agent in the host computer device and a server in a network 190-3.

In this example embodiment, agent 440 includes translator resource 480 and display function 485. In general, display function 485 transmits a copy of images (e.g., display information 166) displayed on display screen 130-2 over network 190-3 to remote source 170. Via received display information 166, the remote source 170 initiates display of a copy of the images on display screen 130-1. Accordingly, an entity at remote source 170 can view a copy of images displayed on the display screen 130-2 host computer device 210-1.

User 108-1 (or any other suitable person) can provide control input with respect to the displayed copy of images on display screen 130-1. Remote source 170 transmits the control input 165-1 over network 190-3 to translator resource 480 of agent 440. As its name suggests, the translator resource 480-1 then translates the received control input 165-1 into control input 165-2. To execute commands as intended by control input 165-1, the translator resource 480 forwards the control input 165-2 to control appropriate functions 413 supported by application core 475.

FIG. 5 is an example diagram illustrating execution of an application according to embodiments herein.

Assume in this example that host computer device 210-1 executes application 150-1-EXE in a manner as previously discussed.

In one embodiment, application core 475 includes a respective display manager 520. When the application 150-1-EXE is activated (e.g., in a foreground on display screen 130-2), the display manager 520 produces appropriate display information for display on display screen 130-2. The display information can specify settings of images displayed in different regions of the display screen 130-2.

For example, display element 560-1 in a first display region can represent a selectable symbol such as an icon, button, etc., in a corresponding displayed graphical user interface enabling the user to perform a first function; display element 560-2 in a second display region can represent a selectable symbol enabling the user to perform a second function; display element 560-3 in a third display region can represent a data field enabling the user to provide text input; display region 560-4 can represent a background of the application on which the display elements 560 are overlaid; and so on.

Application core 475 can include a hierarchy 570 of objects 513 (e.g., object 513-1, object 513-2, etc.) indicating how to render a respective image for application 150-1-EXE on display screen 130-2. For example, in one embodiment, among other things, data associated with object 513-1 indicates attributes of displaying display element 560-1; data associated with object 513-2 indicates attributes of displaying display element 560-2; data associated with object 513-3 indicates attributes of displaying display element 560-3; data associated with object 513-4 indicates attributes of displaying display element 560-4; and so on.

Display manager 520 can include or have access to so-called z-information indicating on ordering of the display elements in a z-axis. That is, the z-information can define how the different elements associated with the application 150-1-EXE are to be overlaid onto each other to render the images on display screen 130-1. Using the z-information, the display manager 520 displays an appropriate image on display screen 130-2.

Host computer device 210-1 can include one or more hardware resources 502 to detect local user input. The hardware resources 502 can include a touch-screen interface, keyboard, mouse, etc. Via control signals received from hardware resources 502, a respective user local to (e.g., within arms length of) the host computer device 210-1 is able to control the application 150-1-EXE executing on the host computer device 210-1. For example, a user local to host computer device 210-1 can select display element 560-1 displayed on display screen 130-2. In response to the selection, the operating system and/or application 150-1-EXE directs the control input to the appropriate object to which the input pertains. In this example, assume that the control input is directed to display element 560-1 at the remote source 170. The application 150-1-EXE then executes one or more appropriate functions associated with the control input.

In one embodiment, as previously discussed, the agent 440 communicates with the display manager 520 of application 150-1-EXE on the host computer device 210-1 to obtain display information representative of an image of one or more display elements displayed on display screen 130-2. The display function 485 of agent 440 converts the received display information from display manager 520 into an appropriate bit map as display information 166 and transmits the display information 166 over network connection to the remote source 170 for display on display screen 130-1 at the remote source 170.

The entity at remote source 170 applies control input with respect to the images on display screen 130-1. The remote source 170 encodes the input as control input 165-1 and transmits it to the agent 440 over communication link 105. The agent 440 receives the control input 165-1 from the remote source 170 over the network connection (e.g., communication link 105-1).

In addition to specifying details associated with input from a user, assume that the control input 165-1 indicates a corresponding location in a rendition of the display information to which the control input pertains. Based on location information, the agent is able to identify which display element in the copy of display screen 130-2 has been selected via input at the remote location. In other words, the agent 440 uses the location information to identify a corresponding display element on display screen 130-2 to which the control input pertains. The translator resource 480 of agent 440 translates the control input 165-1 received from the remote source 170 into control input 165-2. The translator resource 480 communicates the translated control input 165-2 to an appropriate function of the application 150-1-EXE executing on the host computer device 210-1.

As an example, assume that the translator resource 480 maps a location of particular control input to corresponding display element 560-1 displayed on the display screen 130-2 of the host computer device 210-1. The control input is generated by the remote source 170 in response to the corresponding user tapping on the display element 560-1 on display screen 130-1.

In response to detecting the tapping or selection of the display element 560-1 in the copy of display information at the remote source 170, the translator resource 480 forwards the control input 165-1 (e.g., selection of a display element 560-1) to the appropriate object such as object 513-1 in the application 150-1-EXE. The application core 475 then executes the appropriate function associated the selection of display element 560-1.

Accordingly, the translator resource 480 in agent 440 maps the control input 165—to the appropriate display element and then forwards the control input to the appropriate object associated with the display element. Thus, via the control input 165-1 received from remote source 170, it is possible to remotely control the application 150-1-EXE executing on the host computer device 210-1. In a similar manner, when agent 440 receives control input applied to display element 560-2 at the remote source 170, the translator resource 480 forwards the control input to object 513-2 associated with display element 560-2.

In accordance with further embodiments, the agent 440 can enable simultaneous control of the application 150-1-EXE executing on the host computer device 210-1 from multiple different sources. For example, as mentioned, a user at host computer device 210-1 can provide local to control the application 150-1-EXE via a local hardware interface such as hardware resources 502. Additionally, a user at the remote source 170 can operate a hardware interface at the remote source 170 (e.g., a computer device) to generate control input 165-1 to control the application 150-1-EXE. The agent 440 receives the control input 165-2 and produces control input 165-2. Such an embodiment of simultaneous control is useful when the remote user operating remote source 170 is an instructor or administrator teaching the local user at the host computer device 210-1 how to use the application 150-1-EXE.

For example, according to embodiments herein, the administrator at remote source 170 can view the actions taken by the remote user based on viewing a copy of the images on display screen 130-2 as displayed at the remote source 170. Additionally, the local user can view the actions on display screen 130-2 as inputted by the administrator from the remote source 170. Thus, users at different locations can view each other's operations.

Assume in another example that the remote source 170 is a personal computer operated by application administrator 168-1 and that the control input 165-1 specifies a mouse click down by the application administrator 168-1 at location X1, Y1 on display screen 130-1 and a subsequent mouse click up at X2, Y2 on display screen 130-1 with respect to a rendition of display information 166 displayed on display screen 130-1. In one embodiment, this input corresponds to a swipe gesture to be performed on a target device (e.g., host computer device 210-1) such as an iPhone™, IPAD™, etc.

As previously discussed, the translator resource 480 can be configured to convert the control input 165-1 (e.g., down click, sliding of the mouse pointer, and upclick of the mouse, etc.) into an appropriate swipe gesture as if the corresponding input were generated locally by an input resource of the host computer device 210-1 and determine which functions in the application 150-1-EXE that are to be executed based on the swipe gesture.

Note that the translator resource 480 can be configured to take into account resolution variations with respect to display screens, different sized remote and local display screens, etc.

A portion of the control input 165-1 can specify a location of the corresponding control events (e.g., down click, pointer movement, up click, etc.) with respect to the images (e.g., symbols, text, etc.) displayed on display screen 130-1 to which the operator applies the input commands. The corresponding images on the display screen 130-2 may be displayed in accordance with a different coordinate system than display screen 130-1. The translator resource 480 and/or other suitable resource can be configured to take into account the different coordinate systems by mapping inputted control events with respect to images on the display screen 130-1 to corresponding control events with respect to images on display screen 130-2. Thus, assuming an input is a selection of a given symbol (such as an selectable icon), input applied to the given symbol on display screen 130-1 is translated into an appropriate input to a corresponding symbol on display screen 130-2.

As a further example, any device-level interactions such as keyboard, touch screen events (as received from the remote source 170), etc., to be executed on the host computer device 210-1 can be performed via direct communications by the agent application 440 to the appropriate functions in application 150-1-EXE executing on the host computer device 210-1. As mentioned, this can include executing appropriate functions of the application 150-1-EXE in accordance with the control input. More specifically, assume that a user taps on coordinates (100,200) of the display screen 130-1. The translator resource 480 converts these coordinates to corresponding coordinates on the display screen 130-1 of host computer device 210-1 to execute the appropriate commands with respect to the display elements displayed on display screen 130-2.

In accordance with further embodiments, note that the agent application 140 can be a background process such as a daemon running on the host computer device 210-1 unbeknownst to the operator of the host computer device 210-1. For example, the agent 440 may be configured in a way that the agent 440 does not appear as an available application in a home screen or desktop for execution. The fact that the agent 440 is currently executing on the host computer device 210-1 may not be visible to the operator of the host computer device 210-1. In such an instance, an operator of the host computer device 210-1 may not be able to disable the agent application 140. Via the transmission of a copy of images rendered on display screen 130-2 over network 190-4 to remote source 170, a respective application administrator 168-1 (or operator of remote source 170) is able to monitor and/or control use of a corresponding modified compiled application on the host computer device 210-1.

FIG. 6 is an example diagram illustrating use of different modes according to embodiments herein.

As shown, the user viewing display screen 130-1 at remote source 170 can select one or more different operational modes via input to mode selector 625 displayed on display screen 130-1. In response to selection of a single-ended draw mode, the remote source 170 communicates to the agent 440 to operate in the single-ended draw mode in which drawings produced at the remote source 170 are overlaid onto graphics displayed at the host computer device 210-1. The user 108-1 can locally operate the application 150-1-EXE on host computer device 210-1.

More specifically, assume in this example that the user 108 provides input to mode selector 625 to operate in the single ended draw mode. In response to the command to operate in the single-ended draw mode, the agent 440 configures the executed application to operate as follows.

In the single-ended draw mode, the user at the remote source 170 is able to draw on display screen 130-1. The remote source 170 captures the drawing inputted by the user at the remote source 170 and forwards display information of the drawing (e.g., a circle of display element B in this example) over network 190-3 to agent 440. Agent 440 receives the drawing (e.g., circle of display element B) and initiates display of the drawing as an overlay over the graphics locally generated by host computer device 210-1 onto display screen 130-2. The user at host computer device 210-1 can select display elements A, B, C, D, E, etc., on display screen 130-2 to perform different functions.

Thus, in accordance with the single-ended draw mode, the agent 440 receives input to operate the application 150-1-EXE in a remote drawing overlay mode in which: i) the agent 440 receives overlay graphics (such as a circle around display element B) from the remote source 170 and initiates display of the overlay graphics (such as the circle around display element B) over a rendition of display information generated locally by the application 150-1-EXE and displayed on display screen 130-2. In the single-ended drawing mode, the local user at the host computer device 210-1 is able to control the application 150-1-EXE via input of control commands applied to display elements displayed on the display screen 130-2.

Assume in another example that the user 108 provides input to mode selector 625 to operate in a two-way drawing mode. In response to the command to operate in the two-way draw mode, the agent 440 configures the executed application to operate in the two-way draw mode as follows.

In the two-way draw mode, the user at the remote source 170 is able to draw on display screen 130-1. For example, a corresponding function in application 150-1-EXE overlays graphics onto display screen 130-2 as inputted by the user at the host computer device 210-1. For example, the user at host computer device 210-1 can circle a particular display element. The agent forwards a copy of the display information on display screen 130-2 to the remote source 170 as previously discussed. Accordingly, the user at remote source 170 is able to view a rendition of the graphics on display screen 130-1. The remote source 170 can be configured to capture graphics inputted by the user at the remote source 170 and forward display information of the graphics over network 190-3 to agent 440. Agent 440 receives the graphics and initiates display of the graphics as an overlay over the graphics locally generated by host computer device 210-1 onto display screen 130-2.

Thus, in accordance with the two-way draw mode, the agent 440 receives input to operate the application 150-1-EXE in a drawing collaboration mode in which: i) the agent receives first overlay graphics from the remote source 170 and initiates display of the first overlay graphics over a rendition of display information generated locally by the application 150-1-EXE on the display screen 130-2, and ii) a local user at the host computer device 210-1 produces second overlay graphics that are displayed as an overlay on the display screen 130-2.

In another embodiment, the agent 440 in host computer device 210-1 can activate display of a dialog window on display screen 130-2 based on input from the administrator or user 108-1. For example, the administrator 168-1 can input an appropriate command to mode selector 625 to activate (or populate-up) a respective dialog window (such as dialog window 641). In response to receiving the command, the remote source 170 communicates with the agent 440 to initiate execution of corresponding supplemental code in the host computer device 210-1 to display a dialog window or so-called chat room on display screen 130-2 for viewing by the remote user. Via the displayed dialog window on display screen 130-2, the user 108-1 operates the hardware resources 502 to input text or other suitable information. Assume that the user 108-1 at host computer device 210-1 inputs a message 645 to the dialog box. The agent transmits a copy of the images (including, for example, message 645) as displayed on display screen 130-2 over network 190-3 to remote source 170 for viewing on display screen 130-1. Accordingly, the administrator at the remote source 170 is able to view receive messages such as message 645 from user 108-1. In yet further advanced embodiments, the administrator is also able to input messages in a respective dialog window displayed on display screen 130-2. Thus, the administrator at the remote source 170 is able to communicate messages to the user 108-1 at the host computer device 210-1.

Embodiments herein are not limited to use of a dialog window. Further embodiments herein can include, in response to input from the user 108-1 operating the host computer device 210-1 or an administrator operating the remote source 170, establishing a voice link between the host computer device 210-1 and the remote source 170. The user at host computer device 210-1 and the administrator at the remote source 170 are able to communicate with each other over the voice link. In such an instance, each of the host computer device 210-1 and the remote source 170 include a microphone and a speaker. The speaker at host computer device 210-1 plays back audio spoken into the microphone (by the administrator) located at the remote source 170; the speaker at remote source 170 plays back audio spoken (by the user 108-1) into the microphone located at the host computer device 210-1.

In accordance with yet further embodiments, a user such as an administrator at the remote source 170 can provide input to mode selector 625 indicating to disable use of one or more functions or capabilities associated with the application 150-1-EXE executing on the host computer device 210-1. In response to receiving the command, the agent 440 disables the use of the one or more functions by the application. As a more specific example, the application administrator 168-1 at remote source 170 can generate a command to prevent further use of selectable display element A displayed on display screen 130-1 and display element 130-2. In response to receiving the command, the agent 440 disables a corresponding function associated with display element A.

In accordance with yet further embodiments, a user such as an administrator at the remote source 170 can provide input to mode selector 625 indicating to disable use of the application 150-1-EXE executing on the host computer device 210-1. In response to receiving the command, the agent 440 disables the application 150-1-EXE preventing use of any or all functions supported by the application.

Accordingly, an operator at the remote source 170 is able to remotely control the application 150-1-EXE executing on the host computer device 210-1.

FIG. 7 is an example diagram illustrating a notification network facilitating distribution of messages amongst resources according to embodiments herein.

As shown, communication system 700 includes notification network 190-4 (an instance of network 190-3) providing connectivity between communication resources.

In this example, the host computer device 210-1 is a client connected to a server 120-2 in network 190-4. Network 190-4 can be any suitable network such as a packet-switched network supporting conveyance of messages from one resource to another.

Communication link 105-1 such as a wireless or wired link connects the host computer device 210-1 to network 190-4.

By further way of a non-limiting example, the communication link 105-1 between the host computer device 210-1 and the server 120-2 can be a persistent link (e.g., persistent network connection) even though no communications are transmitted over the communication link 105-1. That is, the host computer device 210-1 and the server 120-2 maintain the communication link 105-1 in an open state even though there may be no traffic transmitted over the communication link 105-1 or presence of another communication device that has joined communication session ABC.

In one embodiment, the agent 440 establishes the communication link 105-1 to enable receipt of communications from any of one or more remote sources in network 190-4. To communicate with the agent 440 on host computer device 210-1, a respective remote source must join the communication session ABC.

In this example, communication link 105-1 has been configured to support communications for communication session assigned identifier ABC. In other words, any other resource in communication system 700 that is part of communication session ABC is able to communicate with the host computer device 210-1 over the communication link 105-1.

Further in this example embodiment, no other computer resources are currently members of communication session ABC. In other words, assume in this example that the remote source 170 (or any other computer) has not yet joined communication session ABC to send messages (e.g., control input 165-1) to control or communicate with the host computer device 210-1. In such an instance, even though the communication link 105-1 is an open communication session, no communications are received by the agent application 140 in the host computer device 210-1 other than possible heartbeat signaling that takes place between the host computer device 210-1 and the server 120-2. More specifically, if desired, the agent application 140 can communicate keep-alive messages in a reverse direction back to server 120-2 to notify the server 120-2 that the communication link 105-1 is still functional.

As previously discussed, the communication link 105-1 can be persistent. For example, the agent can communicate with the operating system of host computer device 210-1 to open a socket. The socket and/or communication link 105-1 opened by the operating system of host computer device 210-1 on behalf of the agent 440 remains active or open even though the host computer device 210-1 happens to be depowered (i.e., turned OFF), in a sleep mode, low-power mode, standby mode, etc. Thus, the agent 440 can receive messages (if they happen to be sent) at any time, regardless of a state of the host computer device 210-1.

As mentioned, the communication link 105-1 can be persistent, akin to a VOIP (Voice Over Internet Protocol) or other suitable type of connection, enabling the agent 440 in the application 150-1-EXE to receive and transmit messages as long the host computer device 210-1 is powered by a respective battery or other source.

Establishing the communication link 105-1 can include opening an appropriate HTTP type communication socket in the host computer device 210-1 enabling the agent 440 to communicate with server 120-2 and other remote resources. In one embodiment, the communication link 105-1 is established via the HTTP 5 protocol (e.g., via an upgrade header in which value=websocket), although any suitable socket can be used.

Communications between endpoints can be Transmission Control Protocol/Internet Protocol type data.

In one non-limiting example embodiment, the servers 120 and communication links 105 in notification network 190-4 facilitate communication between resources via broadcast or multicast messages. For example, a resource such as client 110-2 can be a member of communication session XXY as shown. Respective communication link 105-2 has been established for such communications.

In one embodiment, in response to receiving a message on communication link 105-2 (for communication session XXY) from client 110-2, the server 120-4 sends a broadcast of the received message to other servers in notification network 190-1. The broadcasted message indicates that the message belongs to communication session XXY.

Each of the other servers 120 receiving the broadcast message forwards the message to any clients that are members of the communication session XXY. In this case, server 120-5 receives the broadcasted message associated with communication session XXY and detects that communication link 105-5 to client 110-5 supports communications associated with communication session XXY. The server 120-5 then forwards the message generated by client 110-2 to client 110-5.

Other servers such as server 120-2 receiving the messages for communication session XXY does not forward the message to respective clients 110-3, 110-4, etc., because the message is not directed to such destinations.

Additional details of notification network as discussed herein and corresponding functionality can be found in earlier filed U.S. Provisional Patent Application Ser. No. 61/540,218 entitled “Multi-Party Communication Sessions via Broadcast Notification Network,”, filed on Sep. 28, 2011, the entire teachings of which are incorporated herein by this reference.

Additional details of notification network as discussed herein and corresponding functionality can be found in earlier filed U.S. patent application Ser. No. 13/627,447 entitled “Multi-Party Communication Sessions via Broadcast Notification Network,”, filed on Sep. 26, 2012, the entire teachings of which are incorporated herein by this reference.

FIG. 8 is an example diagram illustrating registry information defining a configuration of the notification network in FIG. 7 according to embodiments herein.

In this example, registry information 220-2 maintained for server 120-2 indicates that the host computer device 210-1 has been assigned use of communication link 105-1 to transmit and receive messages associated with communication session ABC.

Registry information 220-4 associated with server 120-4 indicates that the communication link 105-2 between client 110-2 and the server 120-4 supports communication session XXY and that the communication link 105-3 between client 110-3 and the server 120-4 supports communication session ADE.

Registry information 220-5 associated with server 120-5 indicates that the communication link 105-4 between client 110-4 and the server 120-5 supports communication session ADE. Registry information 220-5 also indicates that the communication link 105-5 between client 110-5 and the server 120-5 supports communication sessions ADE and XXY.

In this manner, the registry information 220 keeps track of the configuration of the network 190-1. Note that registry information 220 can be stored in any suitable location.

As mentioned, in one embodiment, the servers 120 communicate with each other via broadcasting, multi-casting, etc., of notification messages to other servers 120 in the notification network 190-4 regardless of whether a respective server in the notification network 190-4 has any clients registered to participate in the communication session. Thus, all of the servers can receive a transmitted message. However, as mentioned above, only certain servers forward the received message to a respective client depending on whether the respective client is a member of a respective communication session to which the message is directed.

Thus, via messaging as discussed herein, the clients are able to communicate with each other. As mentioned, the communication link 105-1 can be persistent enabling receipt of communications from other members that have joined or that eventually join communication session ABC.

FIG. 9 is an example diagram illustrating how a remote computer can join a communication session in notification network to control a remotely located mobile computer device according to embodiments herein.

Maintaining the communication link 105-1 as a persistently active link enables control of the host computer device 210-1 at any time. For example, assume that the host computer device 210-1 installs and/or executes the agent 440 in a manner as previously discussed. By way of a non-limiting example, the agent 440 can be executing on the host computer device 210-1 even though the host computer device 210-1 may be unpowered or is in a sleep mode.

By way of a non-limiting example, an access manager or central authority in communication system 600 keeps track of the presence/availability of the communication link 105-1. To communicate with the host computer device 210-1, and to control the host computer device 210-1 from remote source 170 as discussed herein, the remote resource 170 can be configured to send one or more messages to an access manager in notification network 190-1 requesting to establish a connection with the host computer device 210-1.

In such an instance, prior to providing information enabling the remote source 170 to communicate with the host computer device 210-1, the access manager in network 190-4 may request that the requesting remote resource such as remote source 170 (e.g., a computer device) and/or user 108 provide appropriate credentials to prove that the requesting party (e.g., user 108, application administrator 168-1, etc.) is authorized to join communication session ABC and communicate with the agent application 140 in the host computer device 210-1.

If the requesting party at remote source 170 provides proper access credentials to the access manager, as shown, the access manager initiates creation of the communication link 105-8. Communication link 105-8 enables the remote source 170 to communicate with the host computer device 210-1 over communication session ABC. In other words, because the remote source 170 becomes a member of session ABC, the remote source 170 is now able to communicate with the agent application 140 on the host computer device 210-1.

Note that the agent 440 may require that the remote source 170 provide further authorization information such as a proper password prior to allowing the user (or other controlling source) at remote source 170 to control the application 150-1-EXE on host computer device 210-1.

Thus, because the communication link 105-1 is persistent, the remote resource 170 (or any other resource) can connect and communicate with the agent 440 in host computer device 210-1 for control purposes at any time.

In a manner as previously discussed, subsequent to joining the communication session ABC via establishing a communication link 105-8 between the remote source 170 and server 120-4, in a manner as previously discussed, the remote source 170 transmits control input 165-1 over communication session ABC to the agent application 140 on the host computer device 210-1. As previously discussed, in a reverse direction over communication session ABC, the host computer device 210-1 transmits display information to the remote source 170.

To remotely control the host computer device 210-1, the remote source 170 sends a message to the host computer device 210-1 over communication session ABC. The operating system of host computer device 210-1 detects presence of the message received on the socket and provides notification to the agent 440 of the message. At a time prior to receiving the notification, the agent 440 may not perform any operations or instructions (e.g., the agent 440 can be configured to use substantially little or no processor clock cycles to execute) until after being notified of the message from the remote source 170. That is, after being notified of a received message, the agent 440 may require use of one or more processor clock cycles to process the received message(s).

Thus, the agent 440 can be configured to receive notification of an attempt by the remote source 170 to contact the agent 440 while the host computer device 210-1 is in a standby mode. In response to receiving the notification, the agent 440 switches its operation from a standby mode in which the agent 440 uses substantially little or no processor clock cycles to an active mode in which the agent 440 receives and processes messages from the remote source 170 received over communication link 105-1 and corresponding socket.

Thus, the host computer device 210-1 as discussed herein can establish a socket on which to receive communications directed to the agent 440. In one embodiment, the agent 440, while in a standby mode, receives notification (e.g., based on a message from the user 108 or other entity at the remote source attempting to remotely control the application 150-1-EXE on host computer device 210-1) from the operating system of host computer device 210-1 that a message was received on the socket assigned for use to receive communications on communication session ABC. In response to receiving the notification, the agent 440 goes into an active mode and initiates execution of the translator resource 480 to translate a respective one or more messages (e.g., control input 165-1) received from the remote source 170.

As previously discussed, it is possible that the host computer device 210-1 is powered down at a time of receiving the message from the remote source 170. In such an instance, the message received from the remote source 170 is still received on the socket. In response to receiving the message, as mentioned above, the operating system of host computer device 210-1 provides notification to the agent 440 that a message has been received on communication session ABC. Even though the host computer device 210-1 may be powered down, the agent 440, application 150-1-EXE, and/or host computer device 210-1 wakes up. The agent 440 utilizes the translator resource 480 to translate the received one or more messages into function calls to the application 150-1-EXE. Thus, in accordance with one embodiment, execution of the translator resource 480 while host computer device 210-1 is un-powered enables control of the application 150-1-EXE on host computer device 210-1.

FIG. 10 is an example diagram illustrating registry information defining a configuration of the notification network in FIG. 6 subsequent to the remote computer joining communication session ABC according to embodiments herein.

As shown, registry information 220-4 has been updated to indicate that remote source 170 is a client coupled to server 120-4 and that communication link 105-8 supports transmission of messages for communication session ABC.

Two-way communications over communication links 105-8 and 105-1 enable the remote source 170 to remotely control application 150-1-EXE on host computer device 210-1.

FIG. 11 is an example block diagram of a computer hardware system for executing operations according to embodiments herein. Any of the functionality and/or resources as discussed herein (e.g., agent 440, host computer device 210-1, remote source 170, servers, etc.) can be executed with computer system 800 or the like to perform functionality as discussed herein.

Computer system 800 (e.g., computer hardware, software, etc.) can be or include one or more computerized devices such as a mobile computer device, personal computer, workstation, portable computing device, mobile device, handheld device, console, network terminal, processing device, network device, etc.

Note that the following discussion provides a basic embodiment indicating how to execute functionality according to embodiments herein using a computer system. However, it should be noted that the actual configuration for carrying out the operations as described herein can vary depending on a respective application.

As shown, computer system 800 of the present example includes an interconnect 811 that couples computer readable hardware storage media 812 (i.e., a non-transitory type of computer readable storage media) in which digital information can be stored and/or retrieved, a processor resource 813 (e.g., one or more processor devices), I/O interface 814, a communications interface 817, etc.

I/O interface 814 provides connectivity to different resources such as a repository, display screen, keyboard, computer mouse, etc.

Computer readable hardware storage medium 812 can be any suitable device such as memory, optical storage, hard drive, floppy disk, etc. In one embodiment, the computer readable storage medium 812 is a non-transitory computer readable storage media (i.e., any hardware storage media ort medium) to store instructions and/or data.

Communications interface 817 enables the computer system 800 and processor device 813 to communicate over a network 190 to retrieve information from remote sources and communicate with other computers. I/O interface 814 enables processor device 813 to retrieve respective information from a repository.

As shown, computer readable storage media 812 can be encoded with agent application 440-1 (e.g., software, firmware, etc.) executed by processor resource 813.

During operation of one embodiment, processor device 813 (e.g., one or more computer devices) accesses computer readable storage media 812 via the use of interconnect 811 in order to launch, run, execute, interpret or otherwise perform the instructions of agent application 440-1 stored on computer readable storage medium 812. Agent application 440-1 can include appropriate instructions, logic, etc., to carry out any or all functionality associated with the resources (e.g., clients, servers, notification network, network administrator, etc.) in a computer network environment as discussed herein.

Execution of the agent application 440-1 produces processing functionality such as agent process 440-2 in processor resource 813. In other words, the agent process 440-2 associated with processor resource 813 represents one or more aspects of executing agent application 440-1 within or upon the processor resource 813 in the computer system 800.

Those skilled in the art will understand that the computer system 800 can include other processes and/or software and hardware components, such as an operating system that controls allocation and use of hardware resources to execute agent application 440-1.

In accordance with different embodiments, note again that computer system 800 (such as a rendition of host computer device 210-1) may be any of various types of devices, including, but not limited to, a mobile computer device, personal computer system, desktop computer, laptop, notebook, netbook computer, mainframe computer system, handheld computer, workstation, network computer, application server, storage device, a consumer electronics device such as a camera, camcorder, set top box, mobile device, portable handheld device, video game console, handheld video game device, a peripheral device such as a switch, modem, router, or in general any type of computing or electronic device.

Functionality supported by resources in network environment and resources therein will now be discussed via flowcharts in FIGS. 12 and 13. Note that there will be some overlap with respect to concepts discussed above for FIGS. 1 through 11. Also, note that the steps in the below flowcharts need not always be executed in the order shown. That is, the steps can be executed in any suitable order.

FIG. 12 is a flowchart illustrating an example method facilitating remote control of a mobile computer device according to embodiments herein.

In processing block 1210, the processing resource 140 receives a compiled application of original executable computer code 125.

In processing block 1220, the processing resource 140 modifies (via modification 151-1) the compiled application of originally compiled executable code 125 to execute agent computer code with respect to the original executable computer code upon instantiation of the application. In one embodiment, the agent code is coded to provide control of the instantiation of the application from a remote source.

In processing block 1230, the application administrator provides access to the modified compiled application 151-1 for installation on at least one host computer.

FIG. 13 is a flowchart illustrating an example method facilitating control of a mobile computer device according to embodiments herein.

In processing block 1310, the host computer device 210-1 receives a request to execute agent 440 installed on the host computer device 210-1. The application installed on the host computer device includes a portion of originally compiled executable code derived from respective source code 112 and a modification 151-1 to the originally compiled executable code.

In response to the request, the host computer device 210-1: i) executes the application 150-1-EXE, and ii) executes an agent 440 on the host computer device 210-1 as specified by the modification 151-1.

Via the agent 440, providing control of the executed application 150-1-EXE on the host computer device 210-1 from a remote source 170.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving a request to execute an application installed on a host computer device, the application installed on the host computer device including a portion of originally compiled executable code derived from respective source code and a modification to the originally compiled executable code;
in response to the request: i) executing the application, and ii) executing an agent on the host computer device as specified by the modification; and
via the agent, providing control of the executed application on the host computer device from a remote source.

2. The method as in claim 1, wherein an application administrator of an organization initiates modification to the originally compiled executable code to enable, via the agent, control of the executed application from the remote source.

3. The method as in claim 1 further comprising:
via the agent executing in the host computer device:
establishing a communication link between the agent and a remote server, the remote source communicating over the communication link with the agent to control the application executing on the host computer device.

4. The method as in claim 1 further comprising:
via the agent executing in the host computer device:
communicating with the application executing on the host computer device to obtain display information representative of an image of display elements generated by the application and displayed on a display screen of the host computer device; and
from the agent, initiating transmission of the display information over an connection to the remote source for display of the display information on a display screen at the remote source.

5. The method as in claim 4 further comprising:
via the agent executing in the host computer device:
receiving control input from the remote source over the network connection, the control input indicating a location in a rendition of the display information at the remote source to which the control input pertains;
translating the control input received from the remote source; and
communicating the translated control input to a respective function of the application executing on the host computer device, the respective function associated with a particular display element at the location in the rendition of the display information.

6. The method as in claim 1 further comprising:
via the agent executing in the host computer device:
initiating transmission of a rendition of display elements associated with the application as display information over a network connection to the remote source, the display elements displayed on a display screen of the host computer device;
receiving control input from the remote source over the network connection, the control input indicating a location in a rendition of the display information at the remote source to which the control input pertains;
mapping the control input to a corresponding display element displayed on the display screen of the host computer device; and
forwarding the control input to a display element object in the application, the display element object executing a function associated with the corresponding display element to which the control is applied.

7. The method as in claim 1 further comprising:
providing simultaneous control of the application executing on the host computer device from multiple sources based on input from multiple users including: i) a local user that provides control input to the application via a local hardware interface of the host computer device, and ii) a remote user that operates a remote hardware interface at the remote source and provides control input from the remote source over a network to the agent.

8. The method as in claim 1 further comprising:
as initiated by the agent, establishing a persistent network connection between the agent in the host computer device and a server in a network, the persistent network connection being a communication link over which the remote source subsequently communicates input commands to the agent to control the application executing on the host computer device.

9. The method as in claim 1 further comprising:
at the agent executing on the host computer device:
receiving input to operate the application on the host computer device in a remote drawing overlay mode in which: i) the agent receives overlay graphics from the remote source and initiates display of the overlay graphics over a rendition of display information generated locally by the application and displayed on a display screen of the host computer device, and ii) a local user at the host computer device controls the application via input of control commands applied to display elements displayed in the rendition of the display information on the display screen; and
configuring the executed application to operate in the remote drawing overlay mode.

10. The method as in claim 1 further comprising:
at the agent executing on the host computer device:
receiving input to operate the application in a drawing collaboration mode in which: i) the agent receives first overlay graphics from the remote source and initiates display of the first overlay graphics over a rendition of display information generated locally by the application on a display screen of the host computer device, and ii) a local user at the host computer device produces second overlay graphics that are displayed over the rendition of display information on the display screen of the host computer device; and
configuring the executed application to operate in the drawing collaboration mode.

11. The method as in claim 1 further comprising:
via the agent executing in the host computer device:
receiving a command from the remote source to modify display parameters of a display element associated with the application executing on the host computer device;
initiating modification of the display parameters associated with the display element; and
the application executing on the host computer device initiating display of the display element on a display screen of the host computer device in accordance with the modified display parameters as specified by the remote source.

12. The method as in claim 1 further comprising:
via the agent executing in the host computer device:
in response to receiving a command from the remote source to disable use of at least one function associated with the application executing on the host computer device, disabling the use of the at least one function by the application.

13. The method as in claim 1 further comprising:
via the agent executing in the host computer device:
in response to receiving a command from the remote source to disable use of the application executing on the host computer device, disabling the use of the application.

14. The method as in claim 1, wherein the agent has read/write access to a memory space of the application executing on the host computer device.

15. A method comprising:
receiving a compiled application of original executable computer code;
modifying the compiled application to execute agent computer code with respect to the original executable computer code upon instantiation of the application, the agent code coded to provide control of the instantiation of the application from a remote source; and
providing access to the modified compiled application for installation on at least one host computer.

16. The method as in claim 15 further comprising:
at the agent executing in the host computer device:
establishing a communication link between the agent and a remote server, the remote source communicating through the communication link and over the communication link with the agent to control the executed application.

17. The method as in claim 1 further comprising:
at the agent executing in the host computer device:
from the agent, over a network connection, initiating transmission of a rendition of display elements associated with the application as displayed on a display screen of the host computer device;
receiving control input from the remote source over the network connection, the control input indicating a location in the rendition of the display information to which the control input pertains;
mapping the control input to a corresponding display element displayed on the display screen of the host computer device; and
forwarding the control input to a display element object in the application, the display element object associated with the corresponding display element to which the control is applied.

18. The method as in claim 1 further comprising:
providing simultaneous control of the application executing on the host computer device from multiple sources based on input from multiple users including: i) a local user that provides control input to the application via a local interface of the host computer device, and ii) a remote user that operates the remote source and provides control input from the remote source over a network to the agent.

19. The method as in claim 1 further comprising:
as initiated by the agent, establishing a persistent network connection between the agent in the host computer device and a server in a network, the persistent network connection being a communication link over which the remote source subsequently communicates input commands to the agent to control the application executing on the host computer device.

20. The method as in claim 1 further comprising:
via the agent executing in the host computer device:
in response to receiving a command from the remote source to disable use of at least one function associated with the executed application, disabling the use of the at least one function by the application.

21. A computer hardware system comprising:
at least one processor device;
a hardware repository that stores instructions associated with an application executed by the at least one processor; and
an interconnect coupling the processor and the hardware repository, the interconnect causing the at least one process device to execute the application and perform operations of:
receiving a request to execute the application installed on a host computer device, the application including a portion of originally compiled executable code derived from respective source code and a modification to the originally compiled executable code;
in response to the request: i) executing the application, and ii) executing an agent on the host computer device as specified by the modification; and
via the agent, providing control of the executed application on the host computer device from a remote source.

22. The computer hardware system as in claim 21, wherein the agent executing in the host computer device establishes a communication link between the agent and a remote server, the remote source communicating through the communication link and over the communication link with the agent to control the application executing on the host computer device.

23. The computer hardware system as in claim 21, wherein the agent executing on the host computer device further supports operations of:
over a network connection, initiating transmission of a rendition of display elements associated with the application as displayed on a display screen of the host computer device;
receiving control input from the remote source over the network connection, the control input indicating a location in the rendition of the display information to which the control input pertains;
mapping the control input to a corresponding display element displayed on the display screen of the host computer device; and
forwarding the control input to a display element object in the application, the display element object executing a function associated with the corresponding display element to which the control is applied.

24. A computer-readable hardware storage medium having instructions stored thereon for processing data information, such that the instructions, when carried out by at least one processing device, cause the at least one processing device to perform operations of:
receiving a request to execute an application installed on a host computer device, the application installed on the host computer device including a portion of originally compiled executable code derived from respective source code and a modification to the originally compiled executable code;
in response to the request: i) executing the application, and ii) executing an agent on the host computer device as specified by the modification; and
via the agent, providing control of the executed application on the host computer device from a remote source.
